(19) United States
(12) Patent Application Publication
(10) Pub. No.: US 2016/0311043 A1
(43) Pub. Date: Oct. 27, 2016

(54) Piezoelectric Injector for Direct Fuel Injection

(71) Applicant: CONTINENTAL AUTOMOTIVE GMBH, Hannover (DE)

(72) Inventors: Rüdiger Garn, Niederwiesa OT Braunsdorf (DE); Thomas Hofmann, Obertraubling (DE); Martin Simmet, Bad Abbach (DE); Thomas Austel, Hartmannsdorf (DE)

(73) Assignee: Continental Automotive GmbH, Hannover (DE)

(21) Appl. No.: 15/101,973

(22) PCT Filed: Dec. 3, 2014
(86) PCT No.: PCT/EP2014/076363

§ 371 Date: Jun. 6, 2016

(30) Foreign Application Priority Data
Dec. 5, 2013 (DE) 10 2013 225 018.5

(51) Int. Cl. B23H 9/14; C25F 7/00; F02M 61/16; C25F 3/14; B23H 3/04; F02M 51/06

(52) U.S. Cl. CPC B23H 9/14; B23H 3/04; F02M 51/0603; F02M 61/168; C25F 3/14; C25F 7/00; B23H 2300/10; F02M 2200/80

(57) ABSTRACT

The invention relates to a method and to a device for producing a nozzle body, in which a nozzle-body blank is processed by means of an electro-chemical processing procedure. A method for producing a nozzle body, may include: preparing a nozzle-body blank which has a central axis and a first and a second axial end; proceeding from the first axial end, incorporating a blank cavity into the nozzle-body blank, producing a blank wall between the blank cavity and an external region of the nozzle-body blank; adapting, by means of an electro-chemical processing procedure which comprises electro-chemical subtraction, at least part of a contour of the blank wall, thereby producing a wall of a cavity of the nozzle body.

### CROSS-REFERENCE TO RELATED APPLICATIONS

This application is a U.S. National Stage Application of International Application No. PCT/EP2014/076363 filed Dec. 3, 2014, which designates the United States of America, and claims priority to DE Application No. 10 2013 225 018.5 filed Dec. 5, 2013, the contents of which are hereby incorporated by reference in their entirety.

### TECHNICAL FIELD

The present disclosure relates to a method and to a device for producing a nozzle body, and specifically to a nozzle-body blank processed by an electro-chemical procedure.

### BACKGROUND

Internal combustion engines are often used to generate high torques, requiring large injected volumes of fuel. At the same time, legislation defining the permissible exhaust emissions of internal combustion engines in motor vehicles demands various measures for lowering the exhaust emissions. Typically, one approach is to lower the exhaust emissions which are generated by the internal combustion engine.

The reduction of exhaust emissions of internal combustion engines, and the improvement of the flow properties and precise dosing of the fluid to be metered are a great challenge when constructing nozzle bodies.

### SUMMARY

The present disclosure relates to a method and a device suitable for producing a nozzle body. The teachings herein may be employed to simplify the processes and contribute to keeping the exhaust emissions in an internal combustion engine low.

According to teachings of the present disclosure, a nozzle-body blank (1) may be provided, which has a central axis (3), and in relation to the central axis (3) has a first and a second axial end. A method for producing a nozzle body from the blank (1) may include: proceeding from the first axial end, a blank cavity (5) is incorporated into the nozzle-body blank (1), and on account thereof a blank wall (7) is configured between the blank cavity (5) and an external region of the nozzle-body blank (1); and by means of an electro-chemical processing procedure which comprises electro-chemical subtraction, at least part of a contour of the blank wall (7) is adapted, thus producing a wall of a cavity of the nozzle body.

In some embodiments, the electro-chemical processing procedure comprises: providing an electrolyte and a cathode (23); incorporating the cathode (23) into the blank cavity (5); incorporating the electrolyte into at least one part-region of the remaining vacant volume of the blank cavity (5); and applying a predefined voltage profile between the cathode (23) and the nozzle-body blank (1).

In some embodiments, the predefined voltage profile comprises a pulsed voltage profile.

In some embodiments, in the context of the electro-chemical processing procedure, part of the contour of the blank wall (7) is adapted in such a manner that a blind hole (11) is configured.

In some embodiments, in the context of the electro-chemical processing procedure, part of the contour of the blank wall (7) is adapted in such a manner that a seat region (13) for a nozzle needle is configured.

In some embodiments, in the context of the electro-chemical processing procedure, part of the contour of the blank wall (7) is adapted in such a manner that a guide region (15) for guiding a nozzle needle is configured.

In some embodiments, the cathode (23) is provided together with a non-conducting component (32) such that the cathode (23) in the context of the electro-chemical processing procedure by way of the non-conducting component (32) is supported on the nozzle-body blank (1).

In some embodiments, the cathode (23) has a cathode cavity (33) which in relation to the central axis (3) is axially penetrating; wherein, in the context of the electro-chemical processing procedure, the electrolyte is incorporated through the cathode cavity (33) into at least a part-region of the remaining vacant volume of the blank cavity (5).

In some embodiments, the provided cathode (23) in the context of the electro-chemical processing procedure in relation to the central axis (3) is set in rotation and/or in the axial direction is set in oscillation.

In some embodiments, prior to the electro-chemical processing procedure, the nozzle-body blank (1) is tempered, and by means of an abrasive process within the blank cavity (5) at least part of the contour of the blank wall (7) of the nozzle-body blank (1) is abraded.

In some embodiments, the non-conducting component (32) in relation to the central axis (3) has an axially penetrating component cavity (34) in which the cathode (23) is disposed so as to be axially movable in relation to the central axis (3); and the non-conducting component (32) has a seat (17); in the context of an abrasive process, part of the contour of the blank wall (7) is adapted in such a manner that a seat region (13) for a nozzle needle is configured; and in the context of the electro-chemical processing procedure, the seat (17) of the non-conducting component (32) is brought to bear on the seat region (13), and the cathode (23) is guided within the component cavity (34) of the non-conducting component (32) such that part of the contour of the blank wall (7) is adapted in such a manner that a blind hole (11) is configured.

In some embodiments, prior to the electro-chemical processing procedure, at least one injection bore (9) which penetrates the blank wall (7) of the nozzle-body blank (1) from the blank cavity (5) into the external region of the nozzle-body blank (1) is incorporated into the region of the blind hole (11) and/or of the seat region (13).

The teachings of the present disclosure may provide a device for producing a nozzle body, wherein the device is configured for carrying out a method as described above.

In some embodiments, a device for processing a workpiece comprises an electrode (25) and a non-conducting component (32). The electrode (25) has a central axis (3), and the non-conducting component (32) in relation to the central axis (3) has an axially penetrating component cavity (34) in which the electrode (25) is disposed so as to be axially movable in relation to the central axis (3), and through which the electrode (25) is guided in the context of a processing procedure.

In some embodiments, the non-conducting component (32) has a seat (17) by way of which the non-conducting component (32) in the context of a processing procedure is brought to bear on the workpiece to be processed.

In some embodiments, the non-conducting component (32) has a stop (36) for the electrode (25).

### BRIEF DESCRIPTION OF THE DRAWINGS

Exemplary embodiments of the invention are explained in more detail hereunder by means of the schematic drawings in which:

FIG. 1 shows a nozzle-body blank;

FIG. 2 shows an embodiment of a cathode having a non-conducting component, in a nozzle-body blank;

FIG. 3 shows an embodiment of a cathode in a nozzle-body blank;

FIG. 4 shows an embodiment of a cathode in a nozzle-body blank;

FIG. 5 shows a nozzle-body blank having injection bores;

FIG. 6 shows a nozzle body.

### DETAILED DESCRIPTION

The present disclosure relates to methods for producing a nozzle body, wherein a nozzle-body blank is provided, which has a central axis, and in relation to the central axis has a first and a second axial end. Proceeding from the first axial end, a blank cavity is incorporated, in particular bored, into the nozzle-body blank such that a blank wall is configured between the blank cavity and an external region of the nozzle-body blank. By means of an electro-chemical processing procedure which comprises electro-chemical subtraction, at least part of a contour of the blank wall is adapted, thus producing a wall of a cavity of the nozzle body.

Proceeding from the nozzle-body blank, in this way in the context of the production, a cavity is produced from the blank cavity, a wall is produced from the blank wall, and a nozzle body is thus produced from the nozzle-body blank. The electro-chemical subtraction may include ECM methods, being the abbreviation of the term electro-chemical machining (ECM). Further examples of electro-chemical subtraction include PECM methods and PEM methods, the abbreviations representing the terms pulsed electro-chemical machining (PECM) and precise electro-chemical machining (PEM), respectively.

In some embodiments, that processing of the nozzle-body blank is performed without mechanical contact. Using electro-chemical processing procedures instead of a chipping method, reduces the effect of hardness and toughness of the material to be subtracted as decisive factors for the electro-chemical processing procedure.

In practice, the symmetry of the nozzle body and also the symmetry of individual part-regions of the nozzle body, both individually as well as in the mutual interaction thereof, have an effect on a flow behavior of a fluid passing therethrough and on the exhaust emissions. In the context of the electro-chemical processing procedure it is possible for a plurality of regions of the nozzle body to be simultaneously processed using one tool, e.g., a cathode. In this manner, faults in the symmetry may be kept low, and/or for existing faults in the symmetry of individual regions in terms of their mutual relationship may be reduced. For example, a contribution toward coaxiality of individual regions of the nozzle body may be readily afforded, and any remaining fault in coaxiality may be minimized. The fault in coaxiality represents a deviation from coaxiality of individual regions of the nozzle body, for example in relation to a central axis of the nozzle body. The smaller the fault in coaxiality, the greater the symmetry of the nozzle body, this having a positive effect on the flow behavior of the fluid passing therethrough, and keeping exhaust emissions low.

Moreover, by means of the procedures described herein, regions of the nozzle body which in the context of an abrasive process cannot be processed become accessible only by way of an electro-chemical processing procedure. Moreover, the electro-chemical processing procedure enables processing of the nozzle-body blank both in a soft condition as well as in a hard condition, since no mechanical contact is required between the nozzle-body blank and the cathode.

In some embodiments, the electro-chemical processing procedure comprises providing an electrolyte and a cathode, incorporating the cathode into the blank cavity, and incorporating the electrolyte into at least one part-region of the remaining vacant volume of the blank cavity. Here, incorporating the cathode and the electrolyte does not necessarily have to be carried out in this sequence, but may also be performed in the reverse sequence or simultaneously. Furthermore, the electro-chemical processing procedure optionally comprises applying a predefined voltage profile which is applied between the cathode and the nozzle-body blank.

In some embodiments, the nozzle-body blank is an anode, and the electro-chemical processing procedure is initiated by a difference between the potentials of the cathode and the anode. In this manner, the blank wall of the nozzle-body blank within the blank cavity may be electro-chemically processed at least in a part-region. Part of the material of the nozzle-body blank is dissolved within that part-region into which the electrolyte has been incorporated. By chemical bonding with ions of the electrolyte, material of the nozzle-body blank is subtracted, part of the blank cavity of the nozzle-body blank being electro-chemically processed in this way without any contact with the cathode. By way of this non-contacting electro-chemical processing procedure, the cathode as a tool is subject to hardly any wear and it is possible for a high volume of nozzle bodies having a substantially constant internal geometry to be produced.

In practice, any wear and an accuracy of guidance of a nozzle needle in a nozzle body are inter alia dependent on the surface finish of the internal geometry of nozzle bodies.

In some embodiments, applying the predefined voltage profile comprises a pulsed voltage profile. This leads to even more precise post-processing or fine-processing of the blank wall of the nozzle-body blank. Such a procedure is referred to as a PECM method. An improved rinsing and cooling effect of the electrolyte may be achieved by way of the intervals which arise between the voltage pulses. On account thereof, an operational gap as a spacing between the cathode and the nozzle-body blank may be minimized, increasing the precision of the electro-chemical processing procedure. In this manner, it is possible for smaller tolerances to be adhered to, while making a contribution toward a high finish of the wall of the cavity of the nozzle body.

In some embodiments, in the context of the electro-chemical processing procedure, part of the contour of the blank wall is adapted in such a manner that a blind hole is configured. By way of the electro-chemical processing procedure it is possible for regions of the blank cavity which by means of other processing methods, for example by way of an abrasive process, have to date not been accessible to be processed. In this manner, the end of the bored blank cavity of the nozzle-body blank, as a precursor to the blind hole, may be post-processed or fine-processed, the blind hole of the nozzle body being thus configured.

In some embodiments, in the context of the electro-chemical processing procedure, part of the contour of the blank wall is adapted in such a manner that a seat region for a nozzle needle is configured. The seat region in relation to the central axis in the direction of the second axial end of the nozzle-body blank has a decreasing spacing, said region thus tapering in a conical manner, for example. If the seat region for the nozzle needle is configured by abrading, prior tempering of the nozzle-body blank is required. By means of the electro-chemical processing procedure, the seat region may be configured or post-processed both in a soft condition as well as in a hard condition of the nozzle-body blank. According to one further design embodiment, in the context of the electro-chemical processing procedure part of the contour of the blank wall is adapted in such a manner that a guide region for guiding a nozzle needle is configured. In this manner, the guide region may be processed alternatively or additionally to a previous abrasive process.

In some embodiments, the cathode is provided together with a non-conducting component. The cathode in the context of the electro-chemical processing procedure by way of the non-conducting component is supported on the nozzle-body blank. Bearing of the cathode by way of the non-conducting component on the nozzle-body blank enables more accurate and more stable positioning of the tool and, on account thereof, more precise post-processing of the nozzle-body blank.

In some embodiments, the cathode has a cathode cavity which in relation to the central axis is axially penetrating. In this manner, in the context of the electro-chemical processing procedure the electrolyte may be incorporated through the cathode cavity into at least a part-region of the remaining vacant volume of the blank cavity.

In some embodiments, the provided cathode in the context of the electro-chemical processing procedure in relation to the central axis is set in rotation and/or in the axial direction is set in oscillation. This post-processing by means of a rotating and/or oscillating cathode, by way of the movements of the tool, enables an improved material exchange of the electrolyte and, on account thereof, an improved rinsing effect, contributing toward more precise post-processing. Moreover, on account of the rotation and/or oscillation of the cathode, asymmetries and/or existing out-of-round faults of the cathode have no or only a minor effect on the symmetry of the adapted regions of the blank cavity.

In some embodiments, prior to the electro-chemical processing procedure, the nozzle-body blank is tempered, and by means of an abrasive process within the blank cavity at least part of the contour of the blank wall of the nozzle-body blank is abraded. When producing a nozzle body, the abrasive process enables configuration of the guide region and/or of the seat region but not, by virtue of the geometry and of accessibility, processing or configuring of the blind hole, respectively. However, burrs which have a disadvantageous effect on the flow behavior of a fluid passing therethrough and on the functionality of the nozzle body are created in the case of the abrasive process on the tail end of abrading of the seat region. These burrs in turn may be subtracted by means of the electro-chemical processing procedure.

In some embodiments, the non-conducting component in relation to the central axis has an axially penetrating component cavity in which the cathode is disposed so as to be axially movable in relation to the central axis. Furthermore, the non-conducting component has a seat. In the context of the electro-chemical processing procedure the seat of the non-conducting component is brought to bear on the seat region, and the cathode is guided within the component cavity of the non-conducting component. In this manner, part of the contour of the blank wall is adapted in such a manner that a blind hole is configured. By positioning the non-conducting component by way of the seat on the seat region of the nozzle-body blank, the cathode may be accurately centered within the blank cavity, the blind hole thus being able to be post-processed in a precise manner.

In some embodiments, prior to the electro-chemical processing procedure at least one injection bore which penetrates the blank wall of the nozzle-body blank from the blank cavity into the external region of the nozzle-body blank is incorporated into the region of the blind hole and/or of the seat region. In the context of the electro-chemical processing procedure, the entry edges of the injection bore in connection therewith are also rounded. In this manner, the electro-chemical processing procedure, apart from processing the surface of the blank cavity of the nozzle-body blank, may also simultaneously serve a further purpose. On account thereof, a further processing procedure, for example hydro-erosive rounding of the injection bores, may be dispensed with.

In some embodiments, a device for producing a nozzle body is configured for carrying out a method as has been described above.

In some embodiments, a device for processing a workpiece comprises an electrode, in particular a cathode, and a non-conducting component. The electrode furthermore has a central axis. The non-conducting component in relation to the central axis has an axially penetrating component cavity in which the electrode is disposed so as to be axially movable in relation to the central axis. In the context of a processing procedure, the electrode is guided through the component cavity, the latter being advantageous for positioning the electrode as a tool, enabling precise processing of the workpiece.

In some embodiments, the non-conducting component has a seat by way of which the non-conducting component in the context of a processing procedure is brought to bear on the workpiece to be processed. According to one further design embodiment, the non-conducting component has a stop for the electrode. In this manner it may be guaranteed that the movable electrode does not come into contact with the workpiece to be processed.

Elements of identical construction or function are referenced using the same reference signs in all figures.

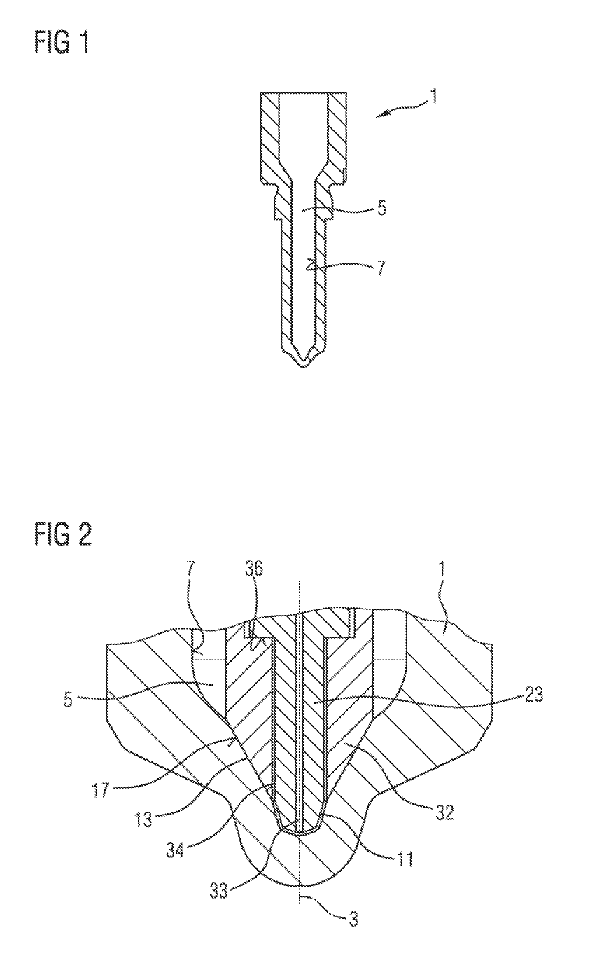

A nozzle-body blank 1 (FIG. 1) has a blank cavity 5 which has been bored into the nozzle-body blank 1, for example. On account thereof, a blank wall 7 has been configured. In the context of an electro-chemical processing procedure a cavity is produced from the blank cavity 5, a wall is produced from the blank wall 7, and a nozzle body is produced from the nozzle-body blank 1.

The nozzle-body blank 1 (FIG. 2) has a central axis 3, and a cathode 23 is disposed together with a non-conducting component 32 within the blank cavity. The non-conducting component 32 has a seat 17 which within the blank cavity 5 bears on a seat region 13. Furthermore, the non-conducting component 32 has a penetrating component cavity 34 in which the cathode 23 is disposed so as to be axially movable in relation to the central axis 3. The cathode 23 has a cathode cavity 33 which is configured so as to be axially penetrating.

In the case of this exemplary embodiment of an electro-chemical processing procedure material is electro-chemically subtracted within the blank cavity 5 of the nozzle-body blank 1, a blind hole 11 of the nozzle body thus being configured. The cathode 23, as a tool, by way of the non-conducting component 32 in the blank cavity 5 is supported on the nozzle-body blank 1, while the cathode 23 in relation to the central axis 3 axially penetrates the non-conducting component 32, protruding into the blank cavity 5 up to an end region thereof. In order to prevent contact with the blank wall 7 of the nozzle-body blank 1, a stop 36 for the axially movable cathode 23 is configured in the component cavity 34. The nozzle-body blank 1 is the workpiece to be processed, and in the context of an ECM (electro-chemical machining) method, or a PECM (pulsed electro-chemical machining) method, or a PEM (precise electro-chemical machining) method functions as an anode. As a result, a short circuit in the context of the electro-chemical processing procedure may be preempted by the stop 36.

Through the cathode cavity 33 of the cathode 23, an electrolyte is incorporated into a remaining vacant volume of the blank cavity 5 such that a difference between the potentials of the cathode 23 and of the nozzle-body blank 1 is introduced by applying a voltage profile, initiating the electro-chemical processing procedure. In this manner, a region of the blank cavity 5 may be post-processed or fine-processed, said region by virtue of the geometry and accessibility not being able to be processed or being able to be processed only in a limited manner by means of other methods, such as an abrasive process, for example.

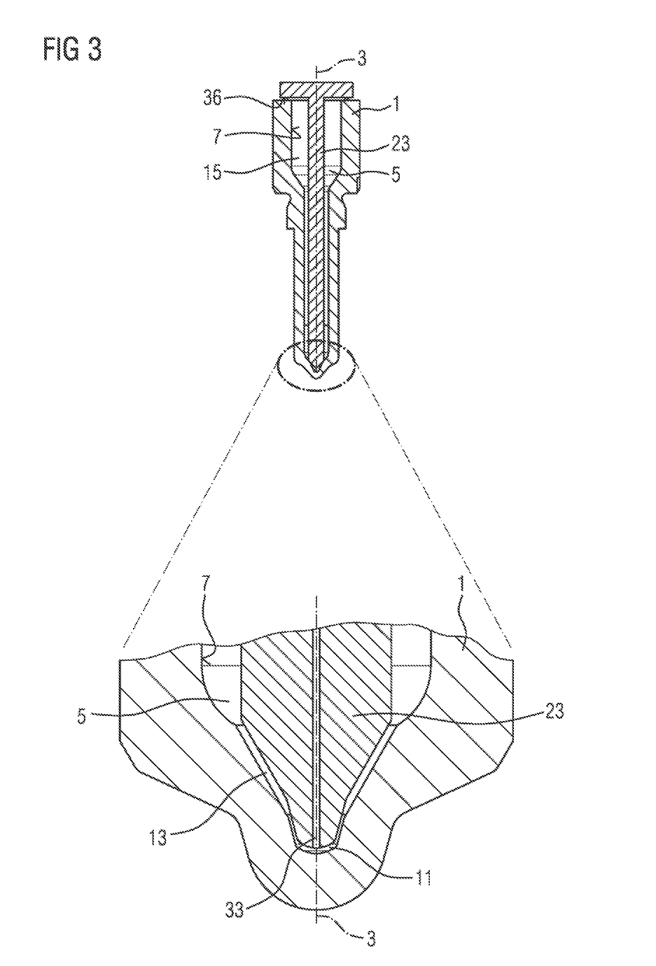

The cathode 23 (FIG. 3) is disposed within the blank cavity 5 of the nozzle-body blank 1 and, proceeding from a first axial end up to a second axial end of the nozzle-body blank 1, protrudes into the blank cavity 5. Said cathode 23 within the blank cavity 5 does not have any non-conducting component 32. Furthermore, the cathode 23 in this exemplary embodiment is configured so as to be T-shaped, having on the first axial end of the nozzle-body blank 1 a stop 36 in relation to the nozzle-body blank 1 outside the blank cavity 5. The stop 36 may be configured as an isolating or non-conducting element, or else as a non-conducting component 32 outside the blank cavity 5. A short circuit between the cathode 23 and the nozzle-body blank 1 in the context of the electro-chemical processing procedure may be prevented by the stop 36.

In the context of the electro-chemical processing procedure, a contour of the blank wall 7 within the blank cavity 5 may be simultaneously adapted in a plurality of part-regions in this manner. For example, the blind hole 11 and the seat region 13 of the nozzle body are thus simultaneously configured with the cathode 23 in this case.

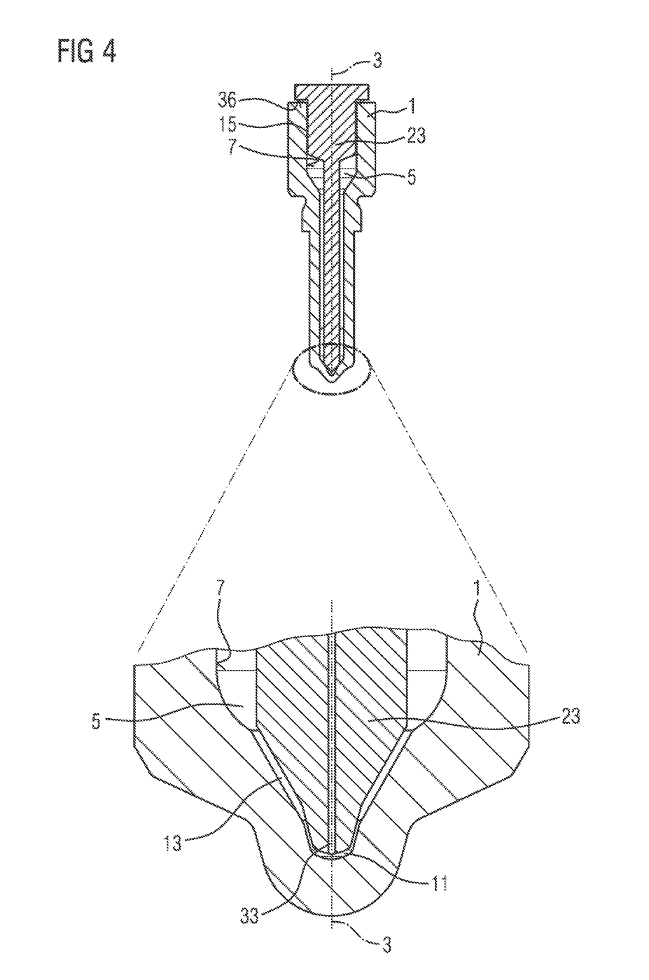

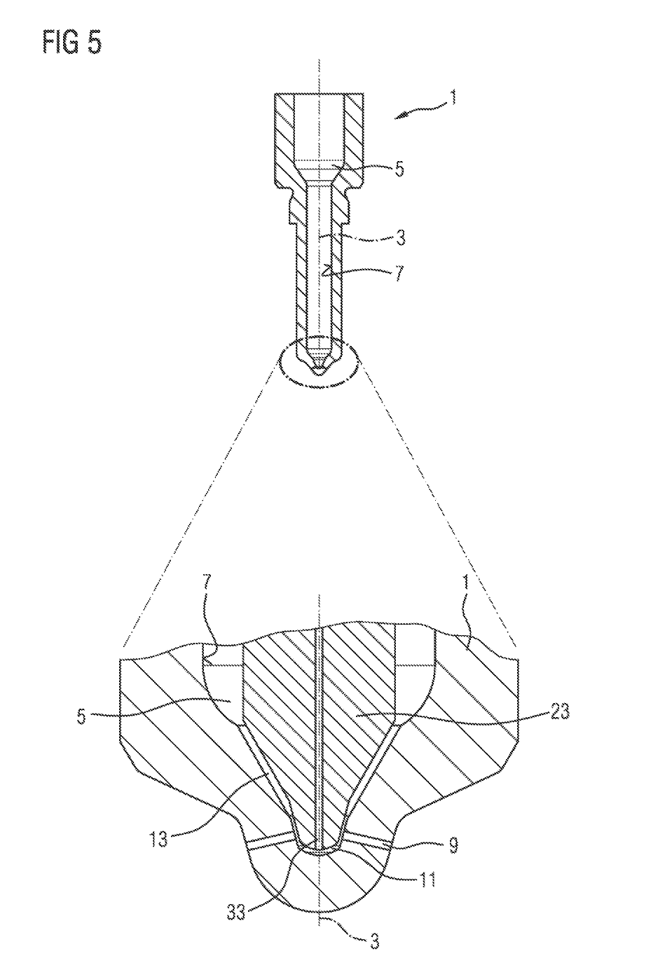

The cathode 23 (FIG. 4) is configured so as to be T-shaped but in the geometry thereof, as opposed to FIG. 3, within the blank cavity 5 has a region in which the cathode 23 is enlarged in a radial manner. The radial enlargement extends to just in front of the blank wall 7 of the nozzle-body blank 1 such that the cathode 23 from there on continues at constant radius in a cylindrical manner. This region, in which the cathode 23 has a larger radius, faces the first axial end of the nozzle-body blank 1 such that in the context of the electro-chemical processing procedure the contour of the blank wall 7 of the blank cavity 5 in this region is adapted in such a manner that the guide region 15 of the nozzle body is configured. Moreover, in further part-regions of the blank cavity 5, the seat region 13 and the blind hole 11 of the nozzle body are simultaneously configured using the same cathode 23. By simultaneously processing a plurality of part-regions of the nozzle-body blank 1, using one cathode 23, faults in the symmetry, such as a fault in the coaxiality of the individual part-regions, are reduced or kept low. This has an advantageous effect on the precision of a nozzle-needle guide in the nozzle body, contributing toward wear and play in the guide of the nozzle needle being kept low.

As compared with the nozzle-body blanks of the preceding exemplary embodiments, the nozzle-body blank 1 (FIG. 5) has injection bores 9 which penetrate the blank wall 7 from the blank cavity 5 through to an external region of the nozzle-body blank 1. In this exemplary embodiment, the injection bores 9 are disposed in that region of the blank cavity 5 in which the blind hole 11 of the nozzle body is configured by the electro-chemical processing procedure. If the injection bores 9 have been incorporated into the nozzle-body blank 1 prior to the electro-chemical processing procedure, the entry edges of the injection bores 9 in the context of the electro-chemical processing procedure are rounded. In this manner, the electro-chemical processing procedure, apart from processing the contour of the blank cavity 5, is employed for a further purpose. A nozzle body having injection bores 9, in which the entry edges of the injection bores 9 are rounded, is thus produced from the nozzle-body blank 1 having injection bores 9. Rounding of the entry edges of the injection bores 9 also has a positive effect on the flow properties of a fluid passing therethrough, contributing toward minimizing the occurrence of turbulences.

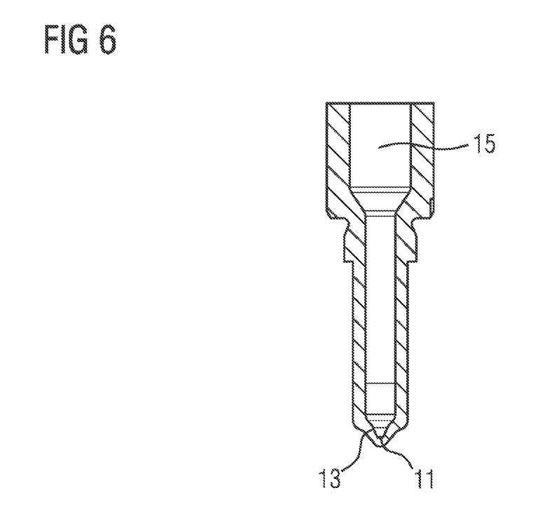

The nozzle body (FIG. 6) is produced from the nozzle-body blank 1 in the context of the electro-chemical processing procedure. The nozzle body comprises the guide region 15, the seat region 13, and the blind hole 11.

### LIST OF REFERENCE SIGNS

1 Nozzle-body blank

3 Central axis

5 Blank cavity

7 Blank wall

9 Injection bore

11 Blind hole

13 Seat region

15 Guide region

17 Seat

23 Cathode

25 Electrode

32 Non-conducting component

33 Cathode cavity

34 Component cavity

36 Stop

What is claimed is:

1. A method for producing a nozzle body, the method comprising:
preparing a nozzle-body blank which has a central axis and in a first and a second axial end;
proceeding from the first axial end, incorporating a blank cavity into the nozzle-body blank, producing a blank wall between the blank cavity and an external region of the nozzle-body blank;
adapting, by means of an electro-chemical processing procedure which comprises electro-chemical subtraction, at least part of a contour of the blank wall, thereby producing a wall of a cavity of the nozzle body.

2. The method as claimed in claim 1, wherein the electro-chemical processing procedure comprises:
providing an electrolyte and a cathode;
inserting the cathode into the blank cavity;
placing the electrolyte into at least one part-region of the remaining vacant volume of the blank cavity; and
applying a predefined voltage profile between the cathode and the nozzle-body blank.

3. The method as claimed in claim 2, wherein the predefined voltage profile comprises a pulsed voltage profile.

4. The method as claimed in claim 1, wherein during the electro-chemical processing procedure part of the contour of the blank wall is adapted to produce a blind hole.

5. The method as claimed in claim 1, wherein during the electro-chemical processing procedure part of the contour of the blank wall is adapted to produce a seat region for a nozzle needle.

6. The method as claimed in claim 1, wherein during the electro-chemical processing procedure part of the contour of the blank wall is adapted to produce a guide region for guiding a nozzle needle.

7. The method as claimed in claim 2, wherein the cathode includes a non-conducting component supporting the cathode on the nozzle-body blank during the electro-chemical processing procedure.

8. The method as claimed in claim 7, wherein the cathode has a cathode cavity extending along the central axis; and
during the electro-chemical processing procedure the electrolyte is placed through the cathode cavity into at least a part-region of the remaining vacant volume of the blank cavity.

9. The method as claimed in claim 2, further comprising rotating or oscillating the cathode during the electro-chemical processing procedure.

10. The method as claimed claim 1, wherein prior to the electro-chemical processing procedure:
preparing a nozzle-body blank includes tempering the blank, and
at least part of the contour of the blank wall is abraded by means of an abrasive process within the blank cavity.

11. The method as claimed in claim 10, wherein:
the cathode includes a non-conducting component supporting the cathode on the nozzle-body blank during the electro-chemical processing procedure;
the cathode is disposed in an axially extending component cavity of the non-conducting component so as to be axially movable in relation to the central axis; and
the non-conducting component has a seat;
during an abrasive process part of the contour of the blank wall is adapted to form a seat region for a nozzle needle is configured; and
during the electro-chemical processing procedure the seat of the non-conducting component is brought to bear on the seat region, and the cathode is guided within the component cavity of the non-conducting component such that part of the contour of the blank wall is adapted to form a blind hole.

11. The method as claimed in claim 4, further comprising forming at least one injection bore which penetrates the blank wall of the nozzle-body blank from the blank cavity into the external region of the nozzle-body blank in the region of the blind hole and/or of the seat region prior to the electro-chemical processing procedure.

12. A device for processing a workpiece, the device comprising:
an electrode with a central axis; and
a non-conducting component with an axially extending component cavity;
wherein the electrode is disposed at least partially within the component cavity and axially movable therein; and
the electrode is guided within the component cavity during a processing procedure.

13. The device as claimed in claim 12, wherein the non-conducting component includes a seat; and
the workpiece to be processed rests on the seat during processing procedure.

15. The device as claimed in claim 12, wherein the non-conducting component includes a stop for the electrode.
